(19) United States
(12) Patent Application Publication
(10) Pub. No.: US 2013/0028156 A1
(43) Pub. Date: Jan. 31, 2013

(54) ACCESS CATEGORY-BASED POWER-SAVE FOR WI-FI DIRECT GROUP OWNER

(71) Applicants: Ramanuja VEDANTHAM, Allen, TX (US); Ariton E. XHAFA, Plano, TX (US); Yanjun SUN, Richardson, TX (US)

(72) Inventors: Ramanuja VEDANTHAM, Allen, TX (US); Ariton E. XHAFA, Plano, TX (US); Yanjun SUN, Richardson, TX (US)

(73) Assignee: TEXAS INSTRUMENTS INCORPORATED, Dallas, TX (US)

(21) Appl. No.: 13/191,121

(22) Filed: Jul. 26, 2011

(51) Int. Cl. H04W 52/02

(52) U.S. Cl. 370/311

(57) ABSTRACT

A wireless device includes a peer-to-peer group owner processor that handles peer-to-peer transactions, a memory coupled to the peer-to-peer group owner processor, and a power state controller. The power state controller determines an access category of a communication received from a peer-to-peer client and determines a quality of service constraint for the access category. The power state controller also determines a power-save mechanism for the wireless device based on the quality of service constraint and implements the determined power-save mechanism.

### BACKGROUND

Recent wireless technology protocols describe power-saving rules and procedures without specifying an algorithm for implementing the power-saving rules and procedures. Additionally, the protocols do not specify how to use multiple power-saving procedures in conjunction with each other.

### SUMMARY

In accordance with an embodiment, a wireless device includes a peer-to-peer group owner processor that handles peer-to-peer transactions, a memory coupled to the peer-to-peer group owner processor, and a power state controller. The power state controller determines an access category of a communication received from a peer-to-peer client and determines a quality of service constraint for the access category. The power state controller also determines a power-save mechanism for the wireless device based on the quality of service constraint and implements the determined power-save mechanism.

In accordance with another embodiment, a method includes determining an access category of a communication received from a peer-to-peer client, determining a quality of service constraint for the access category, determining a power-save mechanism for a peer-to-peer group owner based on the quality of service constraint, and implementing the determined power-save mechanism.

In accordance with yet another embodiment, a computer-readable medium contains instructions that, when executed by a peer-to-peer group owner processor, cause the group owner processor to determine an access category of a communication received from a peer-to-peer client, determine a quality of service constraint for the access category, determine a power-save mechanism for the group owner based on the quality of service constraint, and implement the determined power-save mechanism.

### BRIEF DESCRIPTION OF THE DRAWINGS

For a detailed description of exemplary embodiments of the invention, reference will now be made to the accompanying drawings in which:

FIG. 1 illustrates a network implementing a power-save scheme in accordance with various embodiments;

FIG. 2 illustrates an exemplary opportunistic power-save scheme in accordance with various embodiments;

FIG. 3 illustrates an exemplary notice of allowance power-save scheme in accordance with various embodiments;

FIG. 4 illustrates an exemplary power-save priority scheme in accordance with various embodiments;

FIG. 5 illustrates a method flow chart in accordance with various embodiments; and

FIG. 6 illustrates a machine-readable storage medium implementing a power-save scheme in accordance with various embodiments;

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

A station (“STA”) is any device that contains a medium access control (“MAC”) and physical layer (“PHY”) interface to a wireless medium. An access point (“AP”) is any entity that has STA functionality and provides access to distribution services via the wireless medium for associated STAB. STAB and APs can be readily interchanged in many circumstances.

Peer-to-peer (“P2P”) is a specific communication protocol used by wireless devices as enumerated in the Peer-to-Peer Technical Specification Rev.1.0, May 12, 2009, by the Peer-to-Peer Technical Task Group and hereby incorporated by reference.

A legacy client is a STA that is not compliant with P2P standards. A client is a P2P STA or a legacy client that is connected to a P2P group owner.

A P2P group owner (“group owner”) is an entity that provides and uses connectivity between associated clients and shares many properties of an AP.

A listen state is a mode of operation in which a P2P device dwells on a communication channel.

AP is an abbreviation for access point.

CE is an abbreviation for consumer electronic.

CTWindow is an abbreviation for client traffic window.

NoA is an abbreviation for notice of absence.

OppPS is an abbreviation for opportunistic power-save.

P2P is an abbreviation for peer-to-peer.

PS is an abbreviation for power-save.

STA is an abbreviation for station.

TIM is an abbreviation for traffic information map.

TBTT is an abbreviation for target beacon transmission time.

WMM-PS is an abbreviation for wireless multi-media power-save.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As wireless technologies proliferate, a wide adoption of Wi-Fi CERTIFIED™ products has led to the rapid deployment of many Wi-Fi APs to provide infrastructure for Wi-Fi communications. Wi-Fi communication has been integrated into CE devices and mobile handsets in response to growing Wi-Fi infrastructure. Users of these devices desire to connect to each other in a convenient manner to share, show, print and synchronize content, which has led to a need for P2P connectivity. For example, P2P technology enables a cell phone to communicate with a printer, or another cell phone, or another electronic device without the need for an AP.

A Wi-Fi ALLIANCE® task group is developing a certification program called Wi-Fi DIRECT™ based on a set of software protocols that enable CE and mobile handsets to connect to each other in an ad-hoc fashion and without the need for wireless APs. In a Wi-Fi DIRECT group, P2P clients interface with the P2P group owner in a way similar to a conventional AP. The Wi-Fi DIRECT specification outlines the general operation of a P2P group and specifies the power-save operations for the group owner and the P2P clients.

While the power-save features for the P2P clients are similar to legacy 802.11 stations, the group owner has unique power-save operational requirements. In a legacy network, the AP rarely performs power-save operations. However, the Wi-Fi DIRECT specification requires that the group owner have power consumption similar to that of the P2P clients. This is required because the group owner is also a CE device or mobile handset, which runs on a limited battery supply. Thus, a new power-save mechanism for the group owner is beneficial to reduce or eliminate asymmetric power consumption between the group owner and the P2P clients resulting from the differing roles of the group owner and the P2P clients.

Wi-Fi MULTIMEDIA™ (WMM®) is a Wi-Fi ALLIANCE interoperability certification based on the IEEE 802.11e standard. It provides basic Quality of Service (QoS) features to 802.11 networks. WMM prioritizes traffic according to four access categories (AC)—voice (VO), video (VI), best effort (BE), and background (BKG). In accordance with various embodiments, a power state controller determines a power-save mechanism for the group owner that is based, at least in part, on access categories of communications with one or more P2P clients and the QoS requirements for those access categories. The QoS requirements may be described as “strict” or “minimal” based on the latency and throughput requirements of the particular type of traffic. For example, traffic having a latency requirement of under 100 ms with throughput matching load (e.g., VO, VI) may have a strict QoS service constraint and traffic that is considered to have no latency or throughput requirement (e.g., BE, BKG) may have a minimal QoS service constraint.

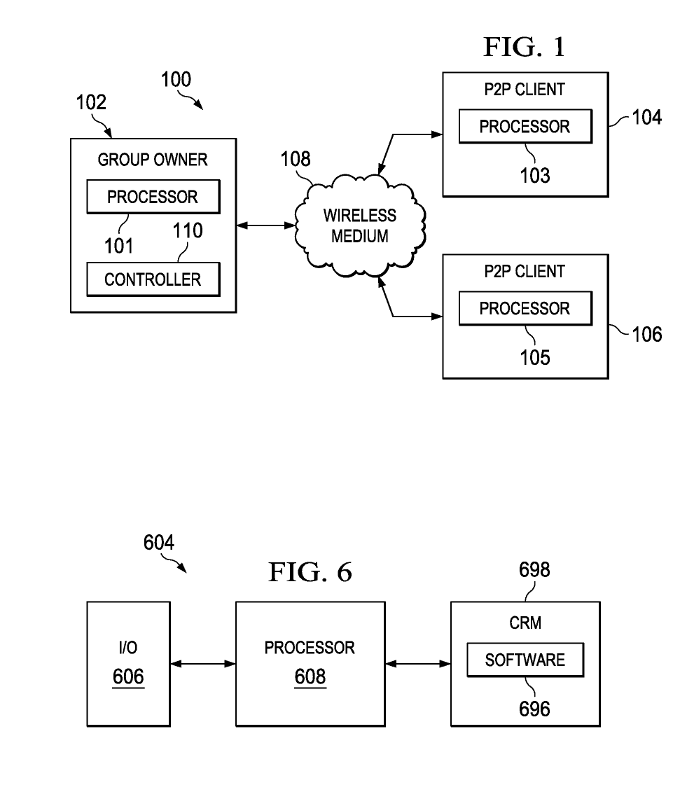

FIG. 1 illustrates a network 100 according to at least one illustrative embodiment. The network 100 comprises a group owner 102 and P2P clients 104 and 106. Each of the network components comprises a processor 101, 103, 105 and memory (not shown) coupled to the processor. In at least one embodiment, any or all of the processors 101, 103, 105 are P2P processors, which handle P2P transactions, execute P2P instructions, and/or communicate via P2P protocol. In accordance with various embodiments, the group owner 102 additionally comprises a power state controller 110, which may be coupled to the P2P group owner processor 101. The power state controller 110 determines appropriate power-save mechanisms and a power state for the group owner 102 (e.g., dozing or awake). The power state controller 110 may be implemented in hardware (e.g., an ASIC) or as software. The network components communicate through a wireless medium 108. The P2P clients 104 and 106 are associated with the group owner 102 (i.e., the group owner 102 uses and provides for communication between the P2P client 104 and the P2P client 106). The network 100 may comprise any number of network components (including more than one of the same component) in any configuration or association.

The Wi-Fi DIRECT specification defines power-save procedures for a group owner. Two such procedures are opportunistic power-save (“OppPS”) and notice of absence (“NoA”). OppPS saves power by allowing the group owner to “doze” (i.e., go to sleep by entering a dormant state that uses little or no power). In order to counteract any unpredictability of dozing, the group owner 102 advertises periods when it will be awake. Such a period is called the client traffic window or CTWindow. The CTWindow usually begins with a beacon frame emitted at a target beacon transmission time (“TBTT”), and extends for the chosen duration represented by the CTWindow value. The beacon alerts clients 104, 106 of the presence of the group owner 102. Clients 104, 106 may request that the group owner be awake at specific time other than during the CTWindow.

The Wi-Fi DIRECT specification recommends that the CTWindow have a duration of at least 10 transmission units, where each transmission unit is 1.024 ms. At any time after the end of each CTWindow, if the group owner 102 determines that the clients 104, 106 themselves are in power-save mode, the group owner may enter a doze state until the next TBTT. However, as long as any client 104, 106 is not in power-save mode, the group owner 102 will remain awake. The client 104, 106 may include a power management (“PM”) bit in its transmissions to the group owner 102 that indicates whether the client 104 is entering a power-save mode.

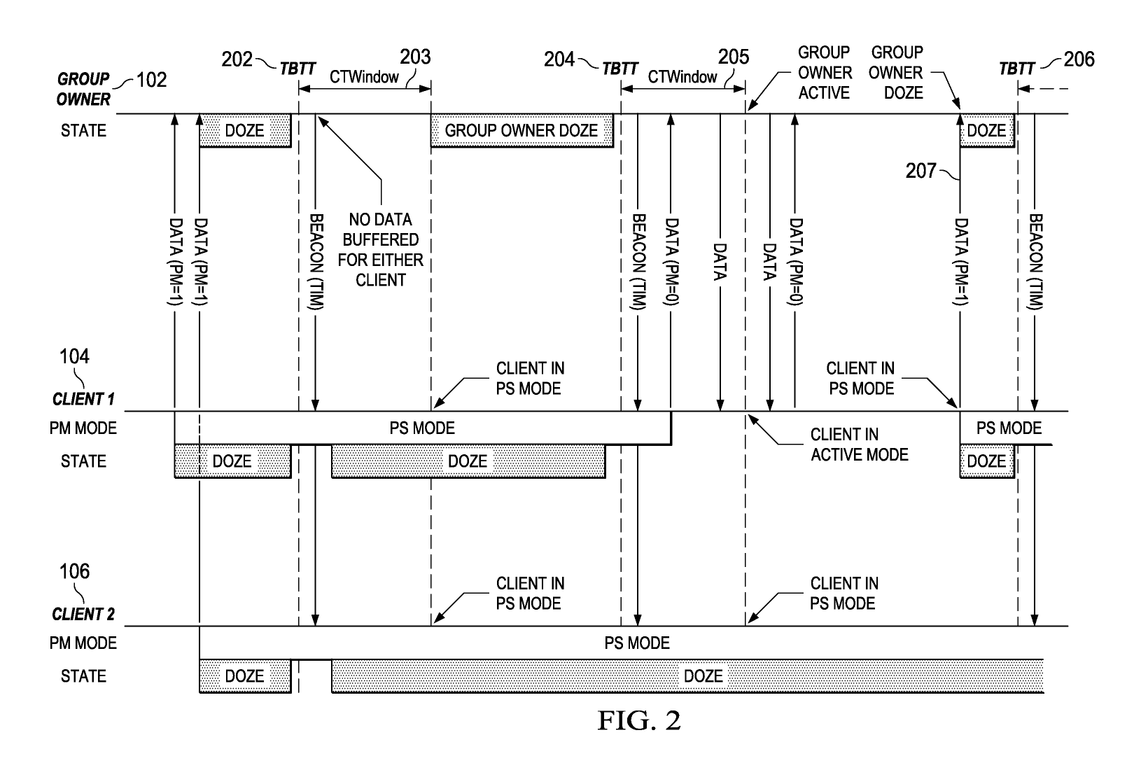

FIG. 2 illustrates an example of OppPS between the group owner 102 and clients 104, 106. In FIG. 2, a PM bit set to 1 indicates to the group owner 102 that the client 104, 106 is entering a power-save mode (i.e., is dozing) and a PM bit set to 0 indicates to the group owner 102 that the client 104, 106 is not entering a power-save mode (i.e., is active). The client 104 sends a data packet with the PM bit set to 1 to the group owner 102 and enters a power-save mode and dozes. Subsequently, the client 106 also sends a data packet with the PM bit set to 1 to the group owner 102 and enters a power-save mode and dozes. At TBTT 202, the group owner transmits a beacon alerting the clients 104, 106 of the presence of the group owner 102. The clients 104, 106 awaken for the transmission of the beacon, but return to a doze state because neither client 104, 106 needs to transmit data to the group owner 102. Thus, the group owner 102 does not receive any transmission from either client during the CTWindow 203 and dozes after the CTWindow 203.

The client 106 does not need to transmit data to the group owner 102 and thus remains in a doze state. However, the client 104 needs to transmit data and thus awakens prior to the TBTT 204 to receive a beacon from the group owner 102. Upon receiving the beacon transmission, the client 104 transmits a data packet with the PM bit set to 0 to the group owner 102 and the group owner 102 responds. In this case, there are ongoing transmissions between the group owner 102 and the client 104 outside of the CTWindow 205 and the PM bit is still set to 0, and thus the group owner 102 does not doze immediately after the CTWindow 205. Later, but before the TBTT 206, the client 104 sends a data packet with the PM bit set to 1. The client 106 remains in a power-save mode. Thus, the group owner 102 dozes prior to the TBTT 206. To summarize, the group owner 102 can doze following the CTWindow if there are no ongoing transmissions. If there is an ongoing transmission, the active duration of the group owner 102 is extended until the transmission is completed. If the group owner 102 subsequently—but before the next TBTT—realizes (e.g., by way of the PM bit) that no clients are active, then the group owner 102 dozes prior to the next TBTT.

Instead of advertising when the group owner 102 will be awake, the group owner 102 can advertise when it will be dozing using a notice of absence (“NoA”). The group owner 102 may advertise through beacons, probe response frames, or NoA action frames. Accordingly, the group owner 102 specifies a start time, interval, duration, and count. The start time indicates the start time of each doze. The interval indicates the duration between absences. The duration indicates the length of each doze. The count indicates the number of doze periods and has a value in the range of 1 to 255. In accordance with various embodiments, a count of 1 indicates a one-time NoA and a count value of 255 indicates an unlimited periodic NoA. Count values between 1 and 255 indicate a finite periodic NoA schedule. In some embodiments, multiple NoA schedules operate concurrently over a period of time.

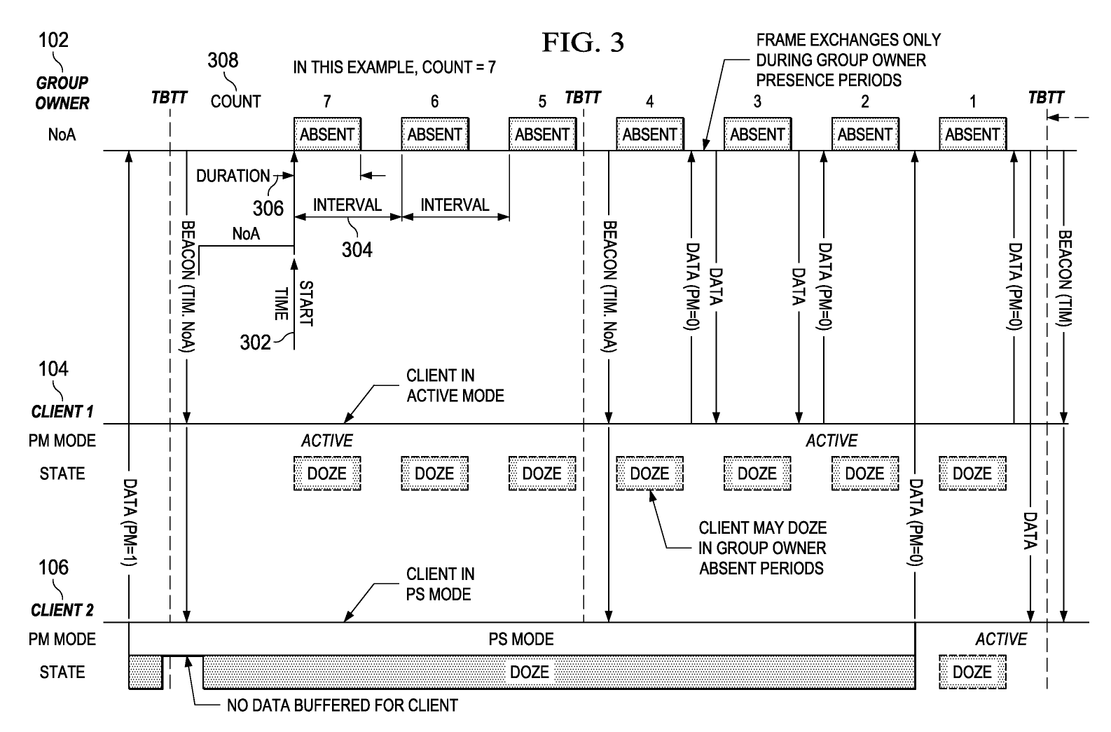

FIG. 3 illustrates an example of a NoA schedule between the group owner 102 and clients 104, 106. A start time 302 indicates when the first doze begins; an interval 304 indicates the length between dozes; a duration 306 indicates the length of each doze; and a count 308 indicates the number of dozes that occur before the NoA schedule is finished. The client 104 is made aware of the NoA schedule via a beacon and may doze during the periods that the group owner 102 dozes because it is known that the group owner 102 will not be available for communication during these periods. Data exchanges between the group owner 102 and the client 104 occur only during the periods in which the group owner 102 is known to be awake. When the client 106 transmits a data packet with the PM bit set to 0, the client 106 also may adopt a doze schedule that corresponds to the doze schedule of the group owner 102.

In accordance with various embodiments, both OppPS and NoA power-save mechanisms may be used simultaneously. Additionally, more than one NoA schedule may operate concurrently over a period of time. Precedence rules determine the group owner 102 power-save state in the event that there is a conflict between power-save mechanisms and a need for the group owner 102 to be awake. The highest precedence is given to a non-periodic NoA power-save (i.e., a NoA schedule with the count equal to 1). The second highest precedence is given to the group owner 102 being awake between the TBTT until the end of the beacon transmission. The third highest precedence is given to the group owner 102 being awake during the CTWindow. Finally, the lowest precedence is given to a periodic NoA power-save (i.e., a NoA schedule with the count greater than 1).

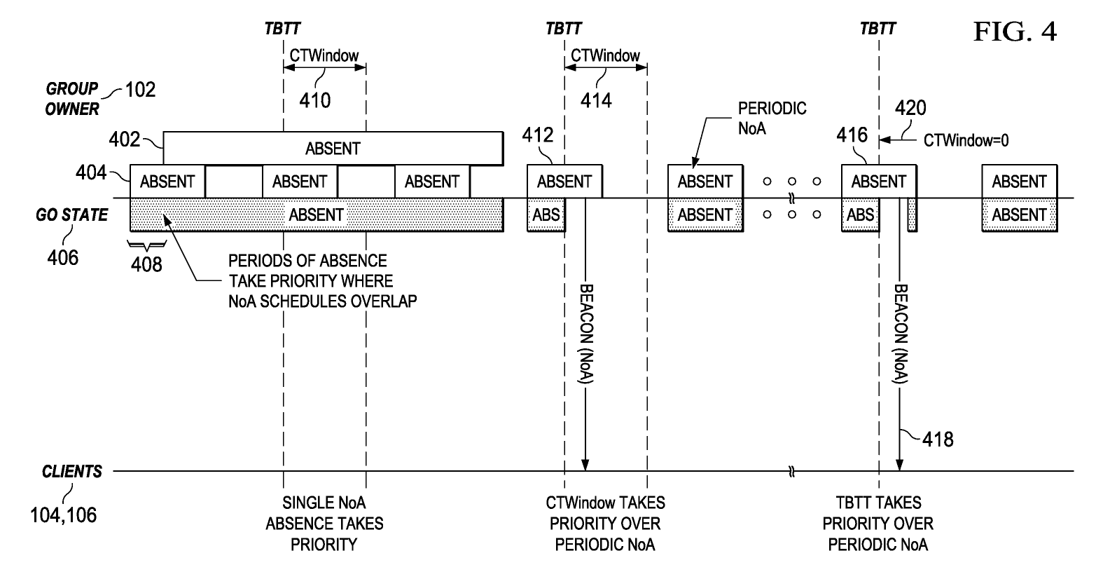

FIG. 4 illustrates the effect of the precedence rules in accordance with various embodiments. The group owner 102 has two NoA mechanisms scheduled—a non-periodic absence 402 (i.e., a NoA schedule with the count equal to 1) and a periodic absence 404, for example an unlimited periodic absence with a count equal to 255. The group owner 102 state 406 is shown below the two NoA schedules; the group owner 102 dozes in the time periods labeled absent and is otherwise awake. The group owner 102 dozes during a time period 408 because a periodic absence is scheduled and it is not during a CTWindow or beacon transmission. The group owner 102 subsequently remains in a doze state because the non-periodic absence 402 has the highest priority. In particular, the group owner 102 dozes during CTWindow 410 because the non-periodic absence 402 has priority. When the duration of the non-periodic absence 402 is complete and no periodic absence is scheduled, the group owner 102 wakes up.

The group owner 102 dozes when periodic absence 412 begins; however, the group owner 102 wakes up when the CTWindow 414 begins, since being awake during the CTWindow 414 has precedence over a periodic NoA power-save. Similarly, the group owner 102 dozes when periodic absence 416 begins and wakes up to transmit beacon 418. However, for exemplary purposes, the duration of the CTWindow 420 is assumed to be zero and thus the group owner 102 is able to doze after the beacon 418 is transmitted and before the end of periodic absence 416. One skilled in the art would appreciate that OppPS dozing is not illustrated in FIG. 4, however could be included in addition to dozing as a result of the NoA schedules.

As explained above, both OppPS and NoA power-save mechanisms may be used simultaneously and more than one NoA schedule may operate concurrently over a period of time. In accordance with various embodiments, two NoA schedules may be used in addition to OppPS for a total of three available power-save mechanisms. However, selection of an appropriate power-save mechanism or combination of power-save mechanisms is necessary to ensure that the QoS requirements are satisfied for the access categories of network traffic. For example, voice traffic (VO) is high priority traffic, which may require the group owner 102 to be awake more frequently and doze less aggressively. Conversely, best effort (BE) and background (BKG) traffic have low QoS constraints, and thus may allow the group owner 102 to doze more frequently or aggressively. Video traffic (VI) has moderate QoS constraints and, in some embodiments, may enable a traffic load-dependent selection of power-save mechanisms at the group owner 102.

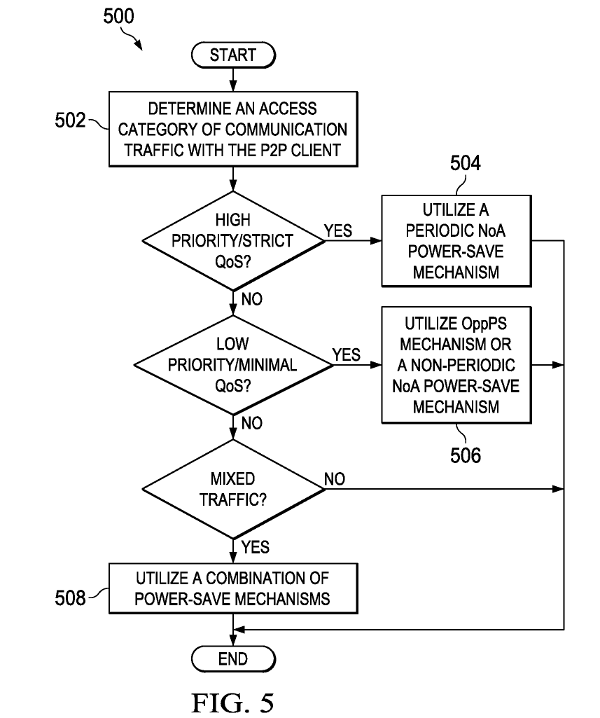

FIG. 5 shows a method 500 of controlling the power state of the group owner 102 in accordance with various embodiments. The method begins when the power state controller 110 of the group owner 102 determines an access category of communication traffic with the P2P client 104 (block 502). If the access category is high priority and has strict QoS constraints, the method continues with the power state controller 110 causing the group owner 102 to utilize a periodic NoA power-save mechanism (block 504). This enables the group owner 102 to doze in a non-aggressive manner, since communications with the P2P client 104 have a higher priority than the periodic absences and periodic NoA carries the lowest precedence. Additionally, certain high-priority traffic such as VO is periodic in nature, which allows the periodic absence interval to be set to the inter-arrival time of VO packets. Thus, the group owner 102 will be awake when VO data packets are transmitted and received.

In some embodiments, the power state controller 110 may cause the group owner 102 to utilize two different periodic NoA power-save mechanisms if the access category is high priority and has strict QoS constraints. For example, bi-directional VO traffic comprises a “speak” state and a “silent” state, with each state having a different periodic interval. The first periodic NoA may have an absence interval that is set to the inter-arrival time of VO packets in the “speak” state and the second periodic NoA may have an absence interval that is set to the inter-arrival time of VO packets in the “silent” state. The absence periods characterized by the second periodic NoA will be overwritten (due to their lower precedence) by “speak” state packets between the group owner 102 and the P2P client 104, although the group owner 102 will doze during the absence periods characterized by the first periodic NoA. However, the group owner 102 is able to doze during the absence periods characterized by the second periodic NoA when “silent” state packets are transmitted between the group owner 102 and the P2P client 104. Thus, the power state controller 110 optimizes the dozing of the group owner 102 by selecting two different NoA schedules for bi-directional VO traffic.

If the access category is low priority and has minimal QoS constraints, the method continues with the power state controller 110 causing the group owner 102 to set the CTWindow to the minimum required duration to sustain traffic (e.g., 10 transmission units as discussed above) and employ an OppPS mechanism (block 506). With an OppPS mechanism and a minimized CTWindow, the group owner 102 dozes at all times other than during the CTWindow. However, because the duration of the CTWindow is sufficient to sustain traffic loads, the group owner 102 is able to service the minimally-constrained QoS traffic, such as BE or BKG traffic.

Alternately, the power state controller 110 causes the group owner 102 to utilize a non-periodic NoA (i.e., a NoA schedule with the count equal to 1) with an active period—or the difference between the NoA interval and the NoA duration—sufficient to sustain the minimally-constrained QoS traffic. A non-periodic NoA schedule is chosen because it is the highest priority; however, the group owner 102 repeats the broadcast of the NoA beacon each period informing the P2P clients 104, 106 of the group owner's 102 NoA, so that the group owner 102 dozes in a periodic manner. Utilizing a non-periodic NoA schedule is a more aggressive power-save mechanism compared to utilizing OppPS with a minimized CTWindow. Thus, in some embodiments, if the traffic access category is BKG, a non-periodic NoA schedule is used because BKG carries a very low QoS constraint and the non-periodic NoA has the highest priority. However, if the traffic access category is BE, an OppPS with a minimized CTWindow may be used because BE carries a slightly higher QoS constraint and OppPS is less aggressive in terms of priority (e.g., because the CTWindow and beacon transmission remain undisturbed).

If the traffic is mixed, and thus there are differing QoS constraints, the method continues with the power state controller 110 causing the group owner 102 to combine power-save mechanisms (block 508), satisfying the strict QoS traffic power-save needs first. For example, if the strict QoS traffic requires two periodic NoA schedules (e.g., bi-directional VO traffic), then the power state controller 110 may elect to perform OppPS for the other traffic type (e.g., BE traffic). Alternately, if the strict QoS traffic requires one periodic NoA schedule, then the power state controller 110 may elect to utilize a non-periodic NoA scheme for the other traffic type (e.g., BKG traffic). As explained above, and in accordance with various embodiments, three power-save mechanisms are available to the group owner 102—two NoA schemes and OppPS. Thus, the power state controller 110 satisfies the strict QoS traffic power-save requirements first and selects the most appropriate remaining power-save mechanism(s) for the other traffic based on the rules outlined above.

Certain access categories, such as VI, have variable QoS constraints. For simplicity, this determination is omitted from FIG. 5. In particular, VI traffic tends to be periodic in nature similar to VO, and thus the power state controller 110 may elect to utilize similar power-save mechanisms for VI and VO traffic. However, VI traffic may have lower QoS constraints in some cases, and thus the power state controller 110 may elect to utilize a combination of power-save mechanisms, such as a NoA schedule combined with OppPS or one periodic NoA schedule combined with one non-periodic NoA schedule.

In addition to determining appropriate power-save mechanisms based on P2P client traffic, in certain situations the power state controller 110 may also determine that the group owner 102 should not utilize any power-save mechanisms. For example, distance between the group owner 102 and the P2P client 104 or interference from another network (e.g., a base station subsystem network) may lead to poor channel conditions between the group owner 102 and the P2P client 104. In this case, data may become backlogged at one or both of the group owner 102 and the P2P client 104, necessitating retries to transmit the backlogged data. If the power state controller 110 determines that such retries are occurring, particularly if the P2P client's PM bit is set to 0 (i.e., the P2P client is active), the power state controller 110 causes the group owner 102 not to enter a power-save state and remain active to alleviate the backlog of data at the group owner 102 and/or the P2P client 104.

Thus, in accordance with various embodiments, the power state controller 110 is configured to determine appropriate power-save mechanisms for the group owner 102 based on the access category or categories of traffic from a P2P client 104, 106. In some instances, the power state controller 110 may determine that dozing is not appropriate and causes the group owner 102 to remain in an active state. The power state controller 110 causes the group owner 102 to utilize power-save mechanisms that are compliant with the Wi-Fi DIRECT specification. Additionally, if all clients are P2P clients, the power state controller 110 reduces the power consumption of the group owner 102.

The system described above may be implemented on any particular machine or computer with sufficient processing power, memory resources, and throughput capability to handle the necessary workload placed upon the computer. FIG. 6 illustrates a particular computer system 604 suitable for implementing one or more embodiments disclosed herein. The computer system 604 includes a processor 608 (which may be referred to as a central processor unit, CPU, or group owner processor) that is in communication with memory devices including storage 698, and input/output (I/O) 606 devices. The processor may be implemented as one or more CPU chips.

In various embodiments, the storage 698 comprises a computer-readable medium such as volatile memory (e.g., RAM), non-volatile storage (e.g., Flash memory, hard disk drive, CD ROM, etc.), or combinations thereof. The storage 698 comprises software 696 that is executed by the processor 608. One or more of the actions described herein are performed by the processor 608 during execution of the software 696.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A wireless device, comprising:
a peer-to-peer group owner processor handling peer-to-peer transactions;
memory coupled to the peer-to-peer group owner processor; and
a power state controller to:
determine an access category of a communication received from a peer-to-peer client and determine a quality of service constraint for the access category;
determine a power-save mechanism for the wireless device based on the quality of service constraint; and
implement the determined power-save mechanism.

2. The wireless device of claim 1 wherein if the quality of service constraint is strict, the power state controller implements a periodic notice of absence power-save mechanism.

3. The wireless device of claim 2 wherein a voice access category comprises a strict quality of service constraint.

4. The wireless device of claim 1 wherein if the quality of service constraint is minimal, the power state controller implements an opportunistic power-save mechanism or a non-periodic notice of absence power-save mechanism.

5. The wireless device of claim 4 wherein a best effort access category and a background access category comprise a minimal quality of service constraint.

6. The wireless device of claim 1 wherein multiple communications are received from the peer-to-peer client, at least some of which have different access categories and quality of service constraints.

7. The wireless device of claim 6 wherein the power state controller implements a combination of power-save mechanisms based on the different quality of service constraints.

8. The wireless device of claim 1 wherein if the power state controller determines that at least one of the group owner processor and the peer-to-peer client has retried sending a data packet and the peer-to-peer client is active, the power state controller does not implement any power-save mechanism.

9. A method, comprising:
determining an access category of a communication received from a peer-to-peer client;
determining a quality of service constraint for the access category;
determining a power-save mechanism for a peer-to-peer group owner based on the quality of service constraint; and
implementing the determined power-save mechanism.

10. The method of claim 9 further comprising implementing a periodic notice of absence power-save mechanism if the quality of service constraint is strict.

11. The method of claim 9 further comprising implementing an opportunistic power-save mechanism or a non-periodic notice of absence power-save mechanism if the quality of service constraint is minimal.

12. The method of claim 9 further comprising receiving multiple communications from the peer-to-peer client, at least some of which have different access categories and quality of service constraints.

13. The method of claim 12 further comprising implementing a combination of power-save mechanisms based on the different quality of service constraints.

14. The method of claim 9 further comprising not implementing any power-save mechanism if at least one of the group owner processor and the peer-to-peer client has retried sending a data packet and the peer-to-peer client is active.

15. A computer-readable medium containing instructions that, when executed by a peer-to-peer group owner processor, cause the group owner processor to:
determine an access category of a communication received from a peer-to-peer client;
determine a quality of service constraint for the access category;
determine a power-save mechanism for the group owner based on the quality of service constraint; and
implement the determined power-save mechanism.

16. The medium of claim 15 further causing the group owner processor to implement a periodic notice of absence power-save mechanism if the quality of service constraint is strict.

17. The medium of claim 15 further causing the group owner processor to implement an opportunistic power-save mechanism or a non-periodic notice of absence power-save mechanism if the quality of service constraint is minimal.

18. The medium of claim 15 wherein the group owner processor receives multiple communications from the peer-to-peer client, at least some of which have different access categories and quality of service constraints.

19. The medium of claim 18 further causing the group owner processor to implement a combination of power-save mechanisms based on the different quality of service constraints.

20. The medium of claim 15 further causing the group owner processor to not implement any power-save mechanism if at least one of the group owner processor and the peer-to-peer client has retried sending a data packet and the peer-to-peer client is active.
